(19) United States
(12) Patent Application Publication
(10) Pub. No.: US 2026/0042688 A1
(43) Pub. Date: Feb. 12, 2026

(54) METHOD FOR REMOVING FLUORIDE IONS FROM WASTEWATER

(71) Applicants: TONGJI UNIVERSITY, SHANGHAI (CN); ONCE ENVIRONMENTAL PROTECTION SCIENCE & TECHNOLOGY (SHANG HAI) CO., LTD., SHANGHAI (CN)

(72) Inventors: FENGTING LI, SHANGHAI (CN); JIANGYI YAN, SHANGHAI (CN); YING WANG, SHANGHAI (CN); JIE LI, SHANGHAI (CN); LU LI, SHANGHAI (CN)

(73) Assignees: TONGJI UNIVERSITY, SHANGHAI (CN); ONCE ENVIRONMENTAL PROTECTION SCIENCE & TECHNOLOGY (SHANG HAI) CO., LTD., SHANGHAI (CN)

(21) Appl. No.: 19/296,050

(22) Filed: Aug. 11, 2025

(30) Foreign Application Priority Data
Aug. 12, 2024 (CN) 2024110949952

(51) Int. Cl. C02F 1/68; C02F 1/00; C02F 1/66; C02F 101/14

(52) U.S. Cl. CPC C02F 1/68; C02F 1/66; C02F 2001/007; C02F 2101/14; C02F 2209/10; C02F 2209/40

(57) ABSTRACT

The present invention provides a method for removing fluoride ions from wastewater. The method comprises the following steps: S1: adjusting the acidity of the fluoride-containing wastewater to be treated; S2: slowly adding white solid particles of calcium sulfate into the acidic fluoride-containing wastewater under high-speed stirring for reaction, allowing them to fully dissolve and mix uniformly, followed by continuous stirring for a period of time and then standing for sedimentation to obtain a suspension; S3: filtering the suspension to complete the removal of fluoride ions from the wastewater. Compared with the prior art, the method provided by the present invention offers advantages such as a short treatment cycle, low equipment requirements, and low cost, making it suitable for large-scale treatment applications.

### TECHNICAL FIELD

The present invention belongs to the technical field of wastewater treatment, and more particularly relates to a method for removing fluoride ions from wastewater.

### BACKGROUND

Fluorine is one of the most common chemical elements on Earth. Its high reactivity allows it to easily combine with other elements to form fluorides, which are widely present in the environment and in industrial processes. Although fluorine brings numerous benefits in industrial and medical fields, its potential health and environmental hazards cannot be ignored. Excessive fluorine can have adverse effects on human health, such as causing dental fluorosis, skeletal diseases, and even more serious health issues. Dental fluorosis is a condition characterized by discoloration and damage to teeth, caused by drinking water with high fluoride content. Excessive fluoride intake may also lead to skeletal fragility and increased risk of fractures. Therefore, strict control and effective removal of fluoride content in drinking water and industrial effluents are of critical importance.

At present, the main treatment methods for fluoride-containing industrial wastewater include adsorption, ion exchange, membrane separation, and coagulation-precipitation. However, these methods have limited treatment capacity, require sophisticated equipment, and may bring negative economic consequences, making it difficult to meet the needs of enterprise development and market demands.

Traditional precipitation methods using basic calcium salts such as calcium oxide (CaO) and calcium hydroxide (Ca(OH)₂) can easily cause significant fluctuations in water pH and require strict control over dosage and reaction conditions, thereby increasing the complexity of operation. Therefore, there is practical industrial value and benefit in providing a method that is simple to operate, capable of achieving resource utilization, and suitable for large-scale wastewater treatment.

### SUMMARY

To overcome the shortcomings of the prior art and to solve at least one technical problem presented in the background art, the present invention provides the following technical solution:

The method for removing fluoride ions from wastewater provided in the present invention comprises the following steps:
S1: Adjusting the acidity of the fluoride-containing wastewater to be treated;
S2: Slowly adding white solid particles of calcium sulfate into the acidic fluoride-containing wastewater under high-speed stirring, allowing them to fully dissolve and mix uniformly, followed by continuous stirring for a period of time and then standing for sedimentation to obtain a suspension;
S3: Filtering the suspension to complete the removal of fluoride ions from the wastewater.

Preferably, the method further comprises the following steps:
S4: Real-time detection of the distance between the lower end of the water suction pipe and the interface using a distance sensor in the treatment tank, and processing the distance data using a processor to convert it into sludge height data, which is then transmitted to a controller;
S5: The controller sends control instructions to a servo motor, which drives a screw rod to rotate and continuously adjusts the height of the lifting plate until the lower end of the water suction pipe is positioned at the interface between the sludge and the suspension;
S6: Activating a negative pressure pump to extract the suspension from the treatment tank through the water suction pipe, telescopic pipe, and water outlet pipe, and filtering the suspension using filtration equipment.

Preferably, in step S2, the white solid particles of calcium sulfate contain 65-90% calcium sulfate, with the remainder being magnetic fly ash.
Preferably, in step S1, a 10% dilute hydrochloric acid solution is added to adjust the pH to 4.9-5.1;
In step S2, the addition amount of the white solid particles of calcium sulfate is 5 g/L, and the stirring speed is 30-50 rpm;
In step S2, the stirring speed remains unchanged before and after adding the white solid particles of calcium sulfate, with a reaction stirring time of 1-2 hours and a standing sedimentation time of 10-15 minutes.

A device for removing fluoride ions from wastewater, applicable to the method for removing fluoride ions from wastewater described above, comprises a treatment tank, a lifting plate, and a water suction pipe.

The treatment tank is provided with a water inlet and a sludge outlet; an installation plate is fixedly connected inside the treatment tank; a first support plate is fixedly connected to the surface of the installation plate; a water outlet pipe is fixedly connected to the surface of the first support plate.

The lifting plate is arranged below the installation plate; a group of guide rods is fixedly connected between the installation plate and the bottom of the treatment tank, and the guide rods penetrate the lifting plate and are slidably connected thereto; a screw rod is rotatably connected between the installation plate and the bottom of the treatment tank, and the screw rod penetrates the lifting plate and is connected thereto through a lead screw and nut pair; the screw rod is driven by a servo motor; a second support plate is fixedly connected to the surface of the lifting plate.

The water suction pipe is fixedly connected to the surface of the second support plate; the water suction pipe and the water outlet pipe are interconnected via a telescopic pipe; a distance sensor is fixedly connected to one side of the second support plate.

Preferably, the device further comprises a processor and a controller; the processor is used to receive the distance data detected by the distance sensor and convert it into sludge height data; the controller is used to receive the data information provided by the processor and automatically adjust the operating state of the servo motor.

Preferably, a filter plate is fixedly connected inside the bottom of the water suction pipe; a coupling shaft is rotatably connected inside the water suction pipe; spiral blades are fixedly connected to the surface of the coupling shaft; one end of the coupling shaft extends below the filter plate and is evenly provided with a group of scraper strips, which are in close contact with the filter plate.

Preferably, the lower end of the water suction pipe is fixedly connected with a baffle via a group of support rods; there is a gap between the baffle and the water suction pipe, and the middle of the baffle protrudes upward.

Preferably, the scraper strips are elastic, and the ends of the scraper strips are fixedly connected with arcuate paddles; a group of elastic damping blocks is evenly distributed inside the water suction pipe at positions corresponding to the scraper strips.

Preferably, a nozzle is fixedly connected to the outer side of the water suction pipe at the position corresponding to the lower end of the distance sensor; one of the damping blocks is designed with a hollow structure and has an elastic element fixedly connected inside; the nozzle and the hollow damping block are interconnected via a conduit; a flexible streamer is fixedly connected inside the nozzle, and the end of the streamer extends out of the nozzle.

The beneficial effects of the present invention are as follows:

1. Compared with the prior art, the defluorinating agent used in the present invention is low in cost and has high adsorption capacity. Waste resources can be selected as raw materials, avoiding the cumbersome preparation process of traditional defluorinating agents.

2. The defluorination method of the present invention only requires adjusting the acidity of fluoride-containing wastewater to promote the formation of stable precipitates between calcium sulfate and fluoride ions. It is applicable to various types of fluoride-containing wastewater and can provide reliable treatment performance even under varying conditions of fluoride concentration. The system operates more stably and reduces the introduction of excessive impurity elements and maintenance demands.

3. The defluorination treatment cycle is short, and the by-products produced have strong disposability, which can be managed by conventional solid waste disposal methods, causing minimal environmental impact.

### BRIEF DESCRIPTION OF THE DRAWINGS

The present invention is further described below in conjunction with the accompanying drawings.

FIG. 1 is a flowchart of the method for removing fluoride ions from wastewater according to the present invention.

FIG. 2 is a workflow diagram of the treatment tank in the present invention.

FIG. 3 is a schematic structural diagram of the treatment tank in the present invention.

FIG. 4 is a schematic structural diagram of the telescopic pipe in the present invention.

FIG. 5 is a schematic structural diagram of the water suction pipe in the present invention.

FIG. 6 is a schematic structural diagram of the filter plate in the present invention.

FIG. 7 is a sectional view of the water suction pipe in the present invention.

FIG. 8 is a partially enlarged view of area A in FIG. 7.

In the drawings: treatment tank 1, installation plate 2, first support plate 3, water outlet pipe 4, lifting plate 5, guide rod 6, screw rod 7, servo motor 8, second support plate 9, water suction pipe 10, telescopic pipe 11, distance sensor 12, filter plate 13, coupling shaft 14, spiral blade 15, scraper strip 16, baffle 17, paddle 18, damping block 19, nozzle 20, elastic element 21, conduit 22, streamer 23, support rod 24, water inlet 25, sludge outlet 26.

### DETAILED DESCRIPTION

To facilitate a clearer understanding of the technical means, creative features, objectives, and effects achieved by the present invention, the invention is further illustrated below in conjunction with specific embodiments.

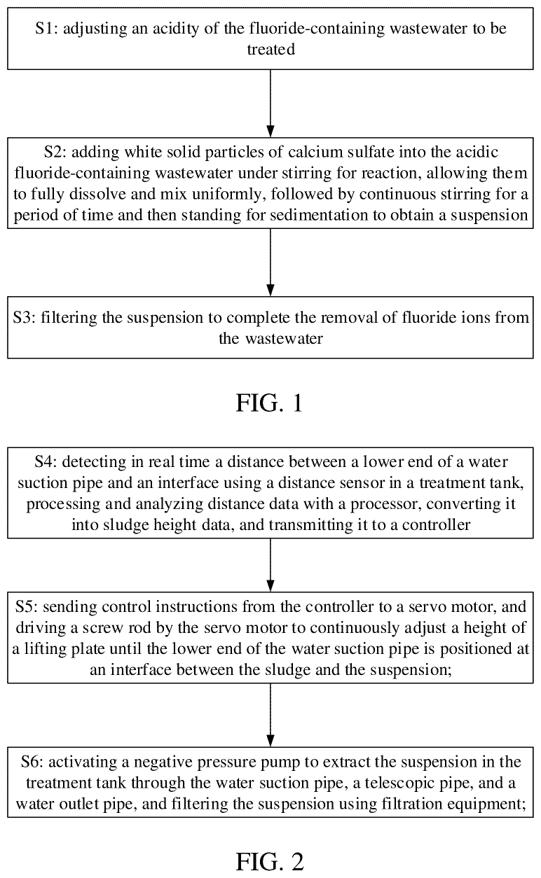

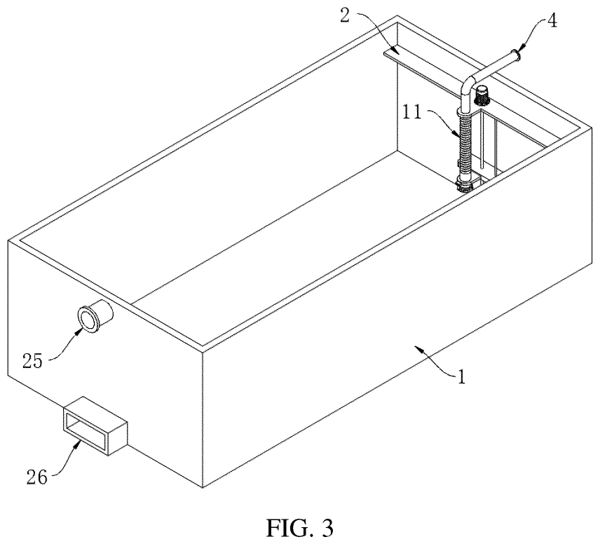

As shown in FIGS. 1 and 2, the method for removing fluoride ions from wastewater according to the present invention comprises the following steps:
S1: Adjusting the acidity of the fluoride-containing wastewater to be treated;
S2: Slowly adding white solid particles of calcium sulfate into the acidic fluoride-containing wastewater under high-speed stirring, allowing them to fully dissolve and mix uniformly, followed by continuous stirring for a period of time and then standing for sedimentation to obtain a suspension;
S3: Filtering the suspension to complete the removal of fluoride ions from the wastewater.

The method further comprises the following steps:
S4: Real-time detection of the distance between the lower end of the water suction pipe 10 and the interface using a distance sensor 12 in the treatment tank 1, and processing the distance data using a processor to convert it into sludge height data, which is then transmitted to a controller;
S5: The controller sends control instructions to the servo motor 8, which drives the screw rod 7 to rotate and continuously adjusts the height of the lifting plate 5 until the lower end of the water suction pipe 10 is positioned at the interface between the sludge and the suspension;
S6: Activating a negative pressure pump to extract the suspension from the treatment tank 1 through the water suction pipe 10, telescopic pipe 11, and water outlet pipe 4, and filtering the suspension using filtration equipment.

In step S2, the white solid particles of calcium sulfate contain 65-90% calcium sulfate, with the remainder being magnetic fly ash. By combining magnetic fly ash with calcium sulfate, the adsorption capacity is further enhanced, the efficiency of precipitation and binding with fluoride ions is improved, and the formation and sedimentation of suspended solids are accelerated, thereby facilitating subsequent separation.

In step S1, a 10% dilute hydrochloric acid solution is added to adjust the pH to 4.9-5.1.

In step S2, the addition amount of the white solid particles of calcium sulfate is 5 g/L, and the stirring speed is 30-50 rpm.

In step S2, the stirring speed remains unchanged before and after the addition of the white solid particles of calcium sulfate. The reaction stirring time is 1-2 hours, and the standing sedimentation time is 10-15 minutes.

The invention is further explained below in combination with a specific embodiment. It should be emphasized that the embodiment described in detail below is merely exemplary and is not intended to limit the scope and application of the present invention.

The initial fluoride-containing wastewater had a fluoride ion concentration of 33.82 mg/L.

The white solid particles of calcium sulfate used had a calcium sulfate content of 80%.

### Embodiment 1

The method for removing fluoride ions from wastewater in this embodiment comprises the following steps:
S1: Adding a 10% dilute hydrochloric acid solution to the fluoride-containing wastewater to adjust the pH to 5.02;
S2: Adding white solid particles of calcium sulfate into the above acidic fluoride-containing wastewater at a stirring speed of 40 rpm, so that the concentration reaches 5 g/L, continuously stirring at the same speed for 1.5 hours, and then standing for 10 minutes to obtain a suspension;
S3: Filtering the above suspension for fluoride content testing.

Defluorination performance test: A fluoride ion electrode was used to measure the fluoride concentration in the solution, which was reduced to 8.48 mg/L.

### Embodiment 2

The method for removing fluoride ions from wastewater in this embodiment comprises the following steps:
S1: Adding a 10% dilute hydrochloric acid solution to the fluoride-containing wastewater to adjust the pH to 5.04;
S2: Adding white solid particles of calcium sulfate into the above acidic fluoride-containing wastewater at a stirring speed of 45 rpm, so that the concentration reaches 5 g/L, continuously stirring at the same speed for 1.5 hours, and then standing for 10 minutes to obtain a suspension;
S3: Filtering the above suspension for fluoride content testing.

Defluorination performance test: A fluoride ion electrode was used to measure the fluoride concentration in the solution, which was reduced to 8.35 mg/L.

The present invention utilizes the favorable wettability of calcium sulfate and its excellent fluoride ion adsorption capacity under specific acidic pH conditions to form stable precipitates with fluoride ions in acidic wastewater. As a result, high-efficiency removal is achieved, reducing the fluoride content to below 10 mg/L. Compared with the prior art, the method for removing fluoride ions provided by the present invention offers advantages such as a short treatment cycle, low equipment requirements, and low cost, making it suitable for large-scale treatment applications.

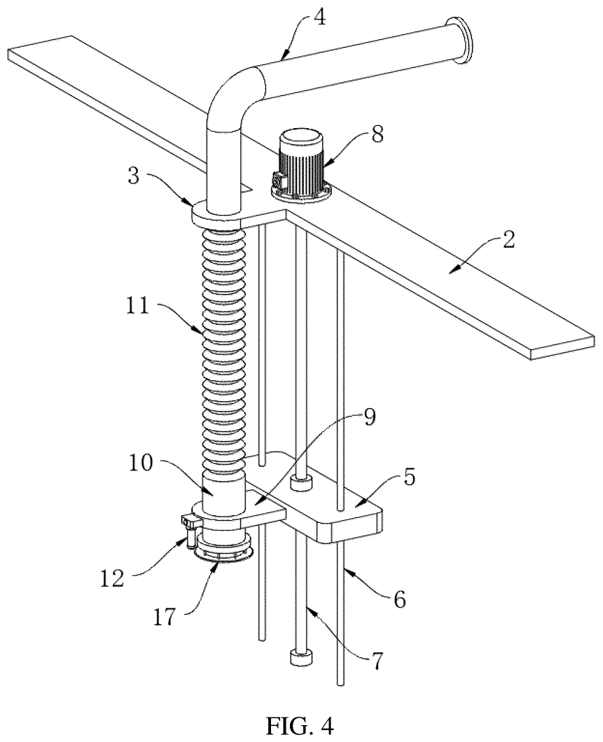

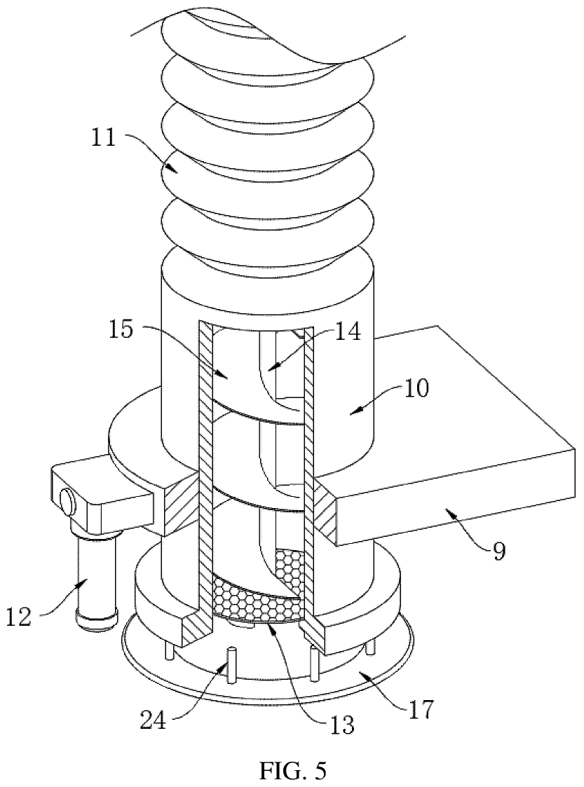

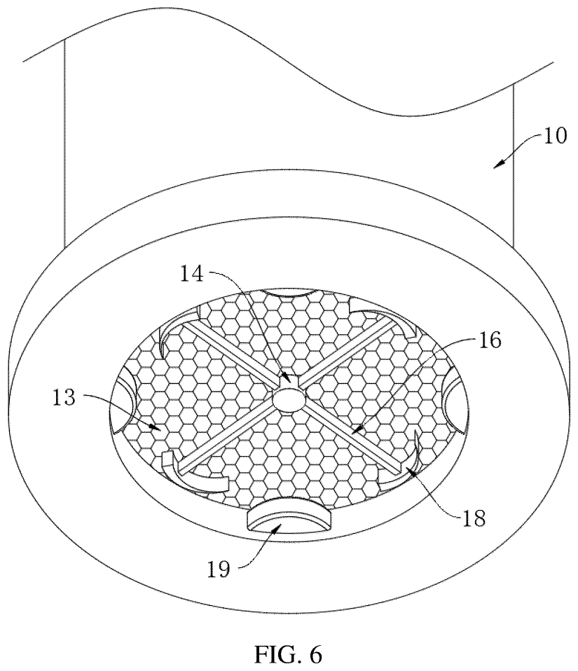

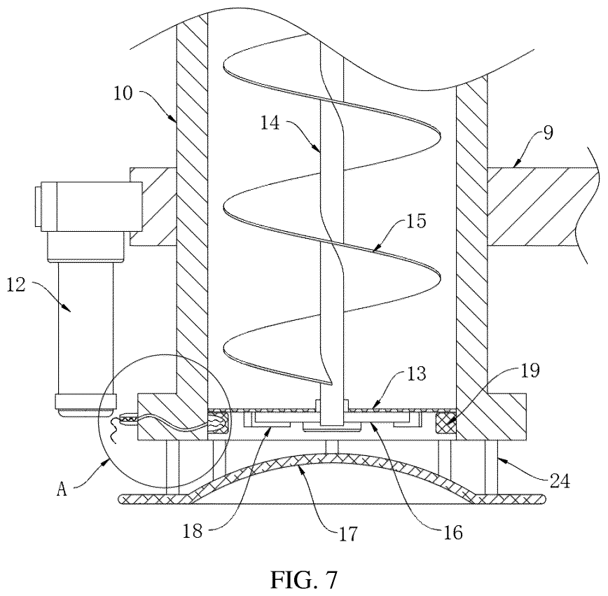

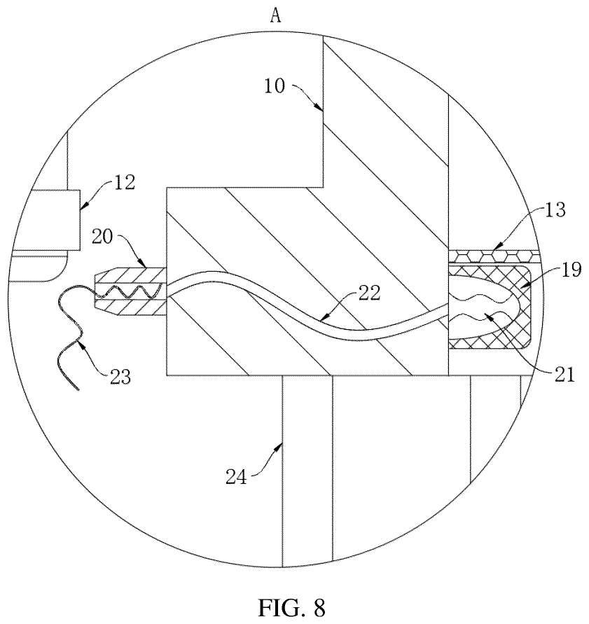

As shown in FIGS. 3 to 8, the device for removing fluoride ions from wastewater according to the present invention, which is applied to the aforementioned method for removing fluoride ions from wastewater, comprises:

A treatment tank 1; the treatment tank 1 is provided with a water inlet 25 and a sludge outlet 26; an installation plate 2 is fixedly connected inside the treatment tank 1; a first support plate 3 is fixedly connected to the surface of the installation plate 2; a water outlet pipe 4 is fixedly connected to the surface of the first support plate 3, and the water outlet pipe 4 is connected to a negative pressure pump.

A lifting plate 5, wherein the lifting plate 5 is disposed below the installation plate 2; a group of guide rods 6 is fixedly connected between the installation plate 2 and the bottom of the treatment tank 1, and the guide rods 6 penetrate the lifting plate 5 and are slidably connected thereto; a screw rod 7 is rotatably connected between the installation plate 2 and the bottom of the treatment tank 1, and the screw rod 7 penetrates the lifting plate 5 and is connected thereto through a lead screw and nut pair; the screw rod 7 is driven by a servo motor 8; a second support plate 9 is fixedly connected to the surface of the lifting plate 5.

A water suction pipe 10, wherein the water suction pipe 10 is fixedly connected to the surface of the second support plate 9; the water suction pipe 10 and the water outlet pipe 4 are interconnected via a telescopic pipe 11, which may be a bellows, hose, multi-stage sleeve pipe, or the like; one side of the second support plate 9 is fixedly connected with a distance sensor 12, which may be an ultrasonic sensor, infrared sensor, laser sensor, visual camera sensor, etc., and the detection end of the distance sensor 12 faces downward.

After the wastewater is treated and allowed to settle, two portions of mixture form inside the treatment tank 1: one portion is sludge at the bottom of the tank, and the other is suspension in the middle and upper layers of the tank. Subsequently, it is necessary to extract the suspension in the middle and upper layers for filtration and discharge the sludge at the bottom. However, in the treatment tank 1 of the prior art, due to variations in fluoride ion and other impurity contents across different types of wastewater, the amount of sludge formed after treatment also varies, making the interface between the sludge and the suspension difficult to predict. In existing treatment tanks 1, the water outlet pipe 4 is usually fixed in position, and its inlet is typically not precisely located at the interface. When extracting the suspension, if the water outlet pipe 4 is positioned above the interface, the suspension cannot be sufficiently extracted; if it is positioned below the interface, the sludge at the bottom will be drawn out.

After the fluoride-containing wastewater is treated in the treatment tank 1, the present invention utilizes the distance sensor 12 to detect in real time the distance between the lower end of the water suction pipe 10 and the interface. This facilitates operators in identifying the sludge height inside the tank. Based on the position of the interface, the servo motor 8 drives the screw rod 7 to rotate, thereby moving the lifting plate 5 vertically along the surface of the guide rods 6. This enables the lower end of the water suction pipe 10 to be positioned at the interface between the sludge and the suspension. During this process, the telescopic pipe 11 can adaptively extend or retract. The negative pressure pump is then activated to extract the suspension from the tank through the water suction pipe 10, the telescopic pipe 11, and the water outlet pipe 4, and the suspension is filtered using external filtration equipment. The water suction pipe 10 in the present invention can be adjusted according to the sludge height inside the tank, thereby ensuring that the lower end of the water suction pipe 10 is positioned appropriately, which improves the practicality of the device.

To enhance pumping efficiency, the lower end of the water suction pipe 10 can be controlled to be slightly above the interface by a small distance. This not only prevents the suction of sludge but also ensures that the suspension inside the tank is sufficiently extracted.

The device further comprises a processor and a controller. The processor is used to receive the distance data detected by the distance sensor 12 and convert it into sludge height data. The controller is used to receive the data provided by the processor and automatically adjust the working state of the servo motor 8. After the distance sensor 12 detects the distance from the interface, the processor processes and analyzes the distance data and converts it into sludge height data, which is then transmitted to the controller. Based on this data, the controller continuously sends control instructions to the servo motor 8, which drives the screw rod 7 to rotate and continuously adjusts the height of the lifting plate 5 until the lower end of the water suction pipe 10 is positioned at the interface. This realizes fully automatic adjustment, avoiding the inaccuracy of manual adjustments and further improving the level of automation of the device.

A filter plate 13 is fixedly connected inside the bottom of the water suction pipe 10. A coupling shaft 14 is rotatably connected inside the water suction pipe 10. Spiral blades 15 are fixedly connected to the surface of the coupling shaft 14. One end of the coupling shaft 14 extends below the filter plate 13 and is evenly provided with a group of scraper strips 16, which are in close contact with the filter plate 13. By providing the filter plate 13, large suspended particles and other impurities can be coarsely filtered during the pumping process through the internal filter plate 13 of the water suction pipe 10. This reduces the filtration pressure in the subsequent treatment steps and prevents clogging of the filtration equipment. During the pumping process, as the water flows through the interior of the water suction pipe 10, it drives the spiral blades 15 to rotate, which in turn rotates the coupling shaft 14, driving multiple scraper strips 16 to rotate. The scraper strips 16 rotate underneath the filter plate 13 and scrape off debris from the surface of the filter plate 13, improving the water throughput of the filter plate 13 and preventing blockage caused by debris accumulating on its surface.

The lower end of the water suction pipe 10 is fixedly connected with a baffle 17 via a group of support rods 24. A gap exists between the baffle 17 and the water suction pipe 10, and the middle of the baffle 17 protrudes upward. By setting the baffle 17 below the water suction pipe 10, it further prevents sludge from being drawn during the pumping process. Since the middle of the baffle 17 bulges upward, after pumping stops, the debris scraped off by the scraper strips 16 can slide outward along the curved surface of the baffle 17 and fall into the sludge at the bottom.

The scraper strips 16 are elastic, and arcuate paddles 18 are fixedly connected to the ends of the scraper strips 16. A group of elastic damping blocks 19 is evenly distributed on the inner side of the water suction pipe 10 at positions corresponding to the scraper strips 16. During the rotation of the scraper strips 16 driven by the coupling shaft 14, when a paddle 18 comes into contact with a damping block 19, the two components press against each other, causing the scraper strip 16 to deform and bend, thereby storing energy. As the coupling shaft 14 continues to rotate, the paddle 18 eventually passes over the damping block 19, and the scraper strip 16 rapidly releases its stored energy through a snapping motion, increasing the impact force applied to debris on the surface of the filter plate 13. This further enhances the removal efficiency of stubborn residues, particularly debris partially embedded in the holes of the filter plate 13, as the strong impact helps dislodge such materials from the holes.

A nozzle 20 is fixedly connected to the outer side of the water suction pipe 10 at a position corresponding to the lower end of the distance sensor 12. The nozzle 20 is oriented toward the bottom end face of the distance sensor 12. One of the damping blocks 19 is designed with a hollow structure, and an elastic element 21 is fixedly connected inside it. The nozzle 20 and the hollow damping block 19 are interconnected via a conduit 22. A flexible streamer 23 is fixedly connected inside the nozzle 20, and the end of the streamer 23 extends outside the nozzle 20. As the paddle 18 presses against the damping block 19, the damping block 19 is also compressed and deformed, forcing water inside the damping block 19 to be expelled through the conduit 22 and nozzle 20, and sprayed onto the bottom end face of the distance sensor 12. This cleans off any debris adhered to the detection end of the distance sensor 12. At the same time, the streamer 23 extends forward under the force of the water flow and swings near the end face of the distance sensor 12, further disturbing the debris and reducing the adhesion between the debris and the sensor, thereby preventing the detection function from being impaired due to blockage. Once the paddle 18 separates from the damping block 19, the elastic element 21 restores the damping block 19 to its original shape and draws water back through the conduit 22 and nozzle 20 for reuse.

In the above description, the terms “front,” “rear,” “left,” “right,” “top,” and “bottom” are based on FIG. 3 of the drawings and follow the perspective of an observer facing the device. The side facing the observer is defined as the front, the left-hand side of the observer is defined as the left, and so on.

In the description of the present invention, it should be understood that the terms such as “center,” “longitudinal,” “lateral,” “front,” “rear,” “left,” “right,” “vertical,” “horizontal,” “top,” “bottom,” “inner,” and “outer” indicate orientations or positional relationships based on the figures, and are used only for the convenience of describing the present invention and simplifying the explanation. These terms are not intended to indicate or imply that the referenced components must have a specific orientation, structure, or operation. Therefore, they should not be construed as limitations on the scope of protection of the present invention.

The above disclosure illustrates and describes the basic principles, main features, and advantages of the present invention. It should be understood by those skilled in the art that the present invention is not limited to the above-described embodiments. The embodiments and description herein are merely for illustrating the principles of the invention. Without departing from the spirit and scope of the invention, various changes and modifications can be made. All such changes and modifications fall within the scope of protection as defined by the appended claims and their equivalents.

1. A method for removing fluoride ions from wastewater, comprising the following steps:
S1: adjusting an acidity of the fluoride-containing wastewater to be treated;
S2: adding white solid particles of calcium sulfate into the acidic fluoride-containing wastewater under stirring for reaction, allowing them to fully dissolve and mix uniformly, followed by continuous stirring for a period of time and then standing for sedimentation to obtain a suspension;
S3: filtering the suspension to complete the removal of fluoride ions from the wastewater;
wherein in step S2, the white solid particles of calcium sulfate comprise 65-90% calcium sulfate, with the remainder being magnetic fly ash;
in step S1, a 10% dilute hydrochloric acid solution is added to adjust the pH to 4.9-5.1;
in step S2, a dosage of the white solid particles of calcium sulfate is 5 g/L, and a stirring speed is 30-50 rpm;
in step S2, the stirring speed remains unchanged before and after the addition of the white solid particles of calcium sulfate, a reaction stirring time is 1-2 hours, and a standing sedimentation time is 10-15 minutes;
the method further comprises the following steps:
S4: detecting in real time a distance between a lower end of a water suction pipe and an interface using a distance sensor in a treatment tank, processing and analyzing distance data with a processor, converting it into sludge height data, and transmitting it to a controller;
S5: sending control instructions from the controller to a servo motor, and driving a screw rod by the servo motor to continuously adjust a height of a lifting plate until the lower end of the water suction pipe is positioned at an interface between the sludge and the suspension;
S6: activating a negative pressure pump to extract the suspension in the treatment tank through the water suction pipe, a telescopic pipe, and a water outlet pipe, and filtering the suspension using filtration equipment;
wherein the treatment tank is provided with a water inlet and a sludge outlet; an installation plate is fixedly connected inside the treatment tank; a first support plate is fixedly connected to a surface of the installation plate; and the water outlet pipe is fixedly connected to a surface of the first support plate;
the lifting plate 5 is disposed below the installation plate; a group of guide rods is fixedly connected between the installation plate and a bottom of the treatment tank, the guide rods penetrating the lifting plate and being slidably connected thereto; the screw rod is rotatably connected between the installation plate and the bottom of the treatment tank, the screw rod penetrating the lifting plate and being connected thereto through a lead screw and nut pair; the screw rod is driven by the servo motor; a second support plate is fixedly connected to a surface of the lifting plate;
the water suction pipe is fixedly connected to a surface of the second support plate; the water suction pipe and the water outlet pipe are interconnected via the telescopic pipe; one side of the second support plate is fixedly connected with the distance sensor;
a filter plate is fixedly connected inside a bottom of the water suction pipe; a coupling shaft is rotatably connected inside the water suction pipe; spiral blades are fixedly connected to a surface of the coupling shaft; one end of the coupling shaft extends below the filter plate and is evenly provided with a group of scraper strips, the scraper strips being in close contact with the filter plate;
the scraper strips are elastic, and arcuate paddles are fixedly connected to ends of the scraper strips; a group of elastic damping blocks is evenly distributed on an inner side of the water suction pipe at positions corresponding to the scraper strips;
a nozzle is fixedly connected to an outer side of the water suction pipe at a position corresponding to a lower end of the distance sensor; one of the damping blocks is designed with a hollow structure, and an elastic element is fixedly connected inside it; the nozzle and the hollow damping block are interconnected via a conduit; a flexible streamer is fixedly connected inside the nozzle, and an end of the streamer extends outside the nozzle.

2. The method for removing fluoride ions from wastewater according to claim 1, wherein the method further comprises using a processor and a controller; the processor is configured to receive distance data detected by the distance sensor and convert the data into sludge height data; the controller is configured to receive the data provided by the processor and automatically adjust an operating state of the servo motor.

3. The method for removing fluoride ions from wastewater according to claim 1, wherein the lower end of the water suction pipe is fixedly connected with a baffle via a group of support rods; a gap is provided between the baffle and the water suction pipe, and a middle of the baffle protrudes upward.
